(19) United States
(12) Patent Application Publication
(10) Pub. No.: US 2024/0054429 A1
(43) Pub. Date: Feb. 15, 2024

(54) MANAGEMENT DEVICE, MANAGEMENT METHOD, AND MANAGEMENT SYSTEM

(71) Applicant: TOYOTA JIDOSHA KABUSHIKI KAISHA, Toyota-shi (JP)

(72) Inventors: Atsushi KOMADA, Nagakute-shi (JP); Mitsuru OGASAWARA, Gamagori-shi (JP); Masahiko ISHII, Okazaki-shi (JP); Hidetaka ASANO, Nissin-shi (JP); Tomokazu ISHII, Okazaki-shi (JP); Koji HETSUGI, Toyota-shi (JP); Kosuke YONEKAWA, Nisshin-shi (JP); Yoshikazu JIKUHARA, Miyoshi-shi (JP)

(73) Assignee: TOYOTA JIDOSHA KABUSHIKI KAISHA, Toyota-shi (JP)

(21) Appl. No.: 18/226,504

(22) Filed: Jul. 26, 2023

(30) Foreign Application Priority Data
Aug. 10, 2022 (JP) 2022-127996

(51) Int. Cl. G06Q 10/0639; G06Q 10/0637; G06Q 10/083

(52) U.S. Cl. CPC G06Q 10/06395; G06Q 10/06375; G06Q 10/083

(57) ABSTRACT

A first management device provided in a first company provided upstream includes a communication unit that acquires position information of a transport vehicle when a product is transported to a second company provided downstream by the transport vehicle. In addition, the first management device includes a processor that performs control to notify the second company of information including an amount of carbon dioxide emitted by manufacturing the product, in a case where detection is made that the transport vehicle has entered premises of the second company based on the acquired position information.

### CROSS-REFERENCE TO RELATED APPLICATION

This application claims priority to Japanese Patent Application No. 2022-127996 filed on Aug. 10, 2022 incorporated herein by reference in its entirety.

### BACKGROUND

### 1. Technical Field

The present disclosure relates to a management device, a management method, and a management system.

### 2. Description of Related Art

With growing awareness of environmental issues, there is growing interest in an emission amount of carbon dioxide emitted for manufacturing products that are distributed on the market. An upstream company in a supply chain may be requested by a downstream company to which products are supplied to disclose the emission amount of carbon dioxide emitted for manufacturing the products. The upstream company calculates the emission amount of carbon dioxide emitted for manufacturing the products and discloses the emission amount of carbon dioxide to the downstream company. For example, Japanese Unexamined Patent Application Publication No. 2016-126372 (JP 2016-126372 A) discloses a method of calculating an emission amount of carbon dioxide in a transportation process of products (including materials and components).

### SUMMARY

Here, the emission amount of carbon dioxide may differ for each supply unit. Therefore, in JP 2016-126372 A, a downstream company needs to request an upstream company to disclose information on the emission amount of carbon dioxide of supplied products each time the products are supplied. The request for disclosure of the information on the emission amount of carbon dioxide to the upstream company is made, for example, by manually inputting a delivery number into a system or making a phone call, and a relatively large amount of man-hours are required. Therefore, it is desirable to suppress an increase in man-hours in the downstream company.

The present disclosure provides a management device, a management method, and a management system capable of suppressing an increase in man-hours in a downstream company.

A first aspect of the present disclosure relates to a management device configured to manage a product to be delivered from a first company to a second company provided downstream of the first company. The management device is provided in the first company. The management device includes a communication unit and a processor. The communication unit is configured to acquire position information of a transport vehicle when the product is transported to the second company by the transport vehicle. The processor is configured to perform control to notify the second company of information including an amount of carbon dioxide emitted by manufacturing the product, in a case where detection is made that the transport vehicle has entered premises of the second company based on the acquired position information.

In the management device according to the first aspect of the present disclosure, as described above, in a case where the first company provided upstream detects that the transport vehicle has entered the premises of the second company provided downstream, the second company is notified of the information including the amount of carbon dioxide. With this, the second company does not need to request the first company to disclose information on an emission amount of carbon dioxide of supplied products each time the products are supplied. As a result, an increase in man-hours at the second company (downstream company) can be suppressed.

In the management device according to the first aspect, the communication unit may be configured to acquire the position information based on global positioning system information of the transport vehicle. With this configuration, the position information of the transport vehicle can be easily acquired based on the global positioning system information.

In the management device according to the first aspect, the processor may be configured to perform control to notify the second company of the information including the amount of carbon dioxide together with delivery information including information regarding delivery of the product. With this configuration, the second company to which the product is delivered can perform management by easily linking the product and the amount of carbon dioxide corresponding to the product.

In the management device according to the first aspect, a basic product constituting the product may be supplied to the first company from a third company provided upstream of the first company. The processor may be configured to perform control to notify the second company of information based on the amount of carbon dioxide emitted by manufacturing the product at the first company and an amount of carbon dioxide emitted by manufacturing the basic product at the third company. With this configuration, the second company also does not need to request disclosure of information on the amount of carbon dioxide emitted by the third company in addition to the amount of carbon dioxide emitted by manufacturing the product at the first company. As a result, an increase in man-hours at the second company (downstream company) can be further suppressed.

A second aspect of the present disclosure relates to a management method of managing a product to be delivered from a first company to a second company provided downstream of the first company. The management method includes acquiring position information of a transport vehicle when the product is transported to the second company by the transport vehicle, detecting that the transport vehicle has entered premises of the second company based on the acquired position information, and notifying the second company of information including an amount of carbon dioxide emitted by manufacturing the product, in a case where detection is made that the transport vehicle has entered the premises of the second company.

In the management method according to the second aspect of the present disclosure, as described above, in a case where the first company detects that the transport vehicle has entered the premises of the second company, the second company is notified of the information including the amount of carbon dioxide. As a result, it is possible to provide a management method capable of suppressing an increase in man-hours in the second company (downstream company).

A third aspect of the present disclosure relates to a management system. The management system includes a first management device and a second management device. The first management device is provided in a first company. The second management device is provided in a second company to which a product is delivered from the first company. The second company is provided downstream of the first company. The first management device includes a communication unit and a processor. The communication unit is configured to acquire position information of a transport vehicle when the product is transported to the second company by the transport vehicle. The processor is configured to perform control to notify the second company of information including an amount of carbon dioxide emitted by manufacturing the product, in a case where detection is made that the transport vehicle has entered premises of the second company based on the acquired position information. The second management device performs management by linking the product and the amount of carbon dioxide with each other based on the information including the amount of carbon dioxide provided through notification.

In the management system according to the third aspect of the present disclosure, as described above, in a case where the first company detects that the transport vehicle has entered the premises of the second company, the second company is notified of the information including the amount of carbon dioxide. As a result, it is possible to provide a management system capable of suppressing an increase in man-hours in the second company (downstream company).

According to the present disclosure, it is possible to suppress an increase in man-hours in the downstream company.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration of a management system according to one embodiment;

FIG. 2 is a diagram showing a packing box packed with a product according to a first embodiment;

FIG. 3 is a sequence diagram of the management system according to the first embodiment;

FIG. 4 is a diagram showing a management table managed in a company provided downstream; and

FIG. 5 is a diagram showing a configuration of a management system according to a modification example of the first embodiment.

### DETAILED DESCRIPTION OF EMBODIMENTS

Hereinafter, an embodiment of the present disclosure will be described in detail with reference to the drawings. In the drawings, the same or corresponding parts are denoted by the same reference numerals, and the description thereof will not be repeated.

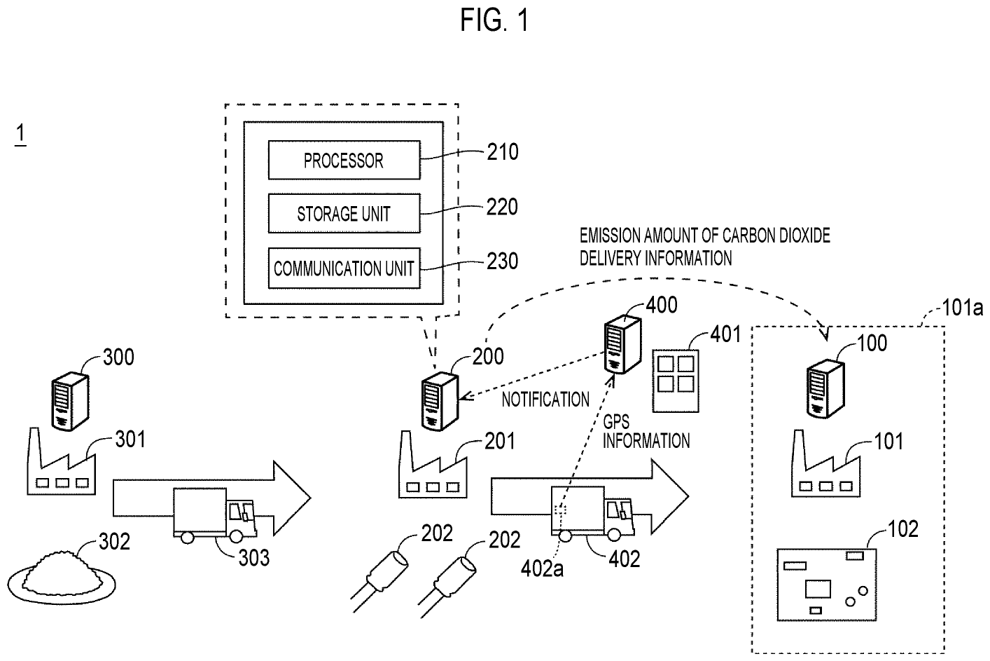

FIG. 1 is a diagram showing a configuration of a management system 1 according to the present embodiment. The management system 1 includes a management device 100 provided in a company 101, a management device 200 provided in a company 201, a management device 300 provided in a company 301, and a server 400 provided in a transport company 401. The company 101 and the company 201 are examples of a “second company” and a “first company” of the present disclosure, respectively. The company 301 is an example of a “third company” of the present disclosure. The management device 100 is an example of a “second management device” of the present disclosure. The management device 200 is an example of a “management device” and a “first management device” of the present disclosure.

The company 101 is provided downstream of the company 201. Specifically, a product 202 is delivered from the company 201 to the company 101. In addition, the company 201 is provided downstream of the company 301. Specifically, a product 302 on which the product 202 is based is delivered from the company 301 to the company 201. The product on which the product 202 is based also includes a component that is combined with other components to constitute the product 202. In addition, a new product 102 manufactured by the company 101 using the product 202 may be delivered to a company provided downstream of the company 101. The product 302 is an example of a “basic product” of the present disclosure.

In addition, the product 202 is manufactured by the company 201 and then is transported to the company 101 by a transport vehicle 402. The transport vehicle 402 is a vehicle managed by the transport company 401.

The transport vehicle 402 is equipped with a global positioning system (GPS) 402a. The server 400 of the transport company 401 acquires a signal (GPS information) from the GPS 402a. The transport company 401 notifies the management device 200 (a communication unit 230) of position information of the transport vehicle 402 based on the GPS information acquired by the server 400.

Further, the product 302 is manufactured by the company 301 and then is transported to the company 201 by a transport vehicle 303.

The management device 200 includes a processor 210, a storage unit 220, and the communication unit 230. The processor 210 controls the communication unit 230. The storage unit 220 stores a program to be executed by the processor 210 as well as information (for example, maps, mathematical expressions, and various parameters) used in the program.

The communication unit 230 communicates with each of the management device 100, the server 400, and the management device 300. The communication unit 230 includes various communication I/Fs.

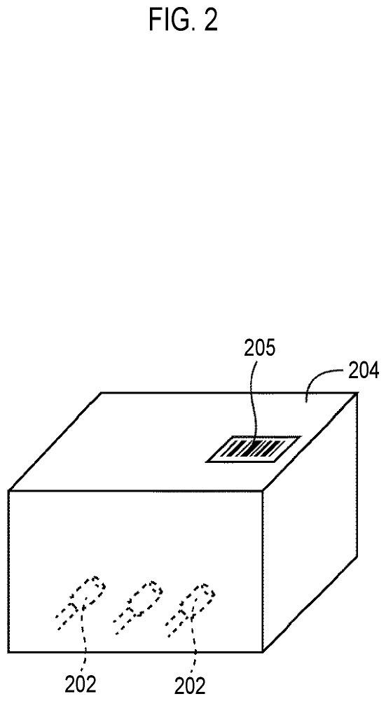

The transport vehicle 402 transports a packing box 204 (see FIG. 2) packed with a plurality of the products 202 to the company 101. A barcode 205 (see FIG. 2) is attached to the packing box 204. The company 101 (management device 100) can acquire delivery information by reading (scanning) the barcode 205. The delivery information includes a delivery number, delivery date and time, information on a supplier company (in this case, the company 201), information on the number of products 202 in the packing box 204, and the like.

Here, in the conventional system, a downstream company (the company 101) needs to request an upstream company (the company 201) to disclose information on an emission amount of carbon dioxide of supplied products each time products are supplied, in order to acquire the information. The request for disclosure of the information on the emission amount of carbon dioxide to the upstream company is made, for example, by manually inputting a delivery number into the system or making a phone call, and a relatively large amount of man-hours are required. Therefore, it is desirable to suppress an increase in man-hours in the downstream company.

In that respect, in the present embodiment, the processor 210 performs control to notify the company 101 (management device 100) of information on an amount of carbon dioxide emitted by manufacturing the product 202, in a case where detection is made that the transport vehicle 402 has entered premises 101a of the company 101 based on the position information of the transport vehicle 402 acquired by the communication unit 230. The transport vehicle 402 having entered the premises 101a means that the transport vehicle 402 has passed through a gate of the company 101. Alternatively, in a case where detection is made that cargo handling work for the product 202 has started in the company 101 or that the transport vehicle 402 has arrived at a cargo handling work area for the product 202, detection may be made that the transport vehicle 402 has entered the premises 101a.

Specifically, the processor 210 provides notification of information of an amount of carbon dioxide emitted by manufacturing the products 202 packed in the transported packing box 204 (that is, an emission amount of carbon dioxide for each packing box 204). The processor 210 performs the notification control through the communication unit 230.

In addition, the processor 210 also notifies the company 101 (management device 100) of information on an amount of carbon dioxide emitted when the transport vehicle 402 transports the product 202, through the communication unit 230. The transport company 401 may notify the company 101 of the emission amount of carbon dioxide during transportation. Alternatively, the processor 210 may notify the company 101 by adding up the emission amount of carbon dioxide when the product 202 is manufactured and the emission amount of carbon dioxide when the product 202 is transported.

In addition, the processor 210 performs control to notify the company 101 of the information on the emission amount of carbon dioxide together with the delivery information (delivery number, and the like) including information regarding the delivery of the product 202. In other words, the processor 210 notifies the company 101 of the delivery information and the information on the emission amount of carbon dioxide as a set through the communication unit 230.

Further, the processor 210 also notifies the company 101 (management device 100) of information on an amount of carbon dioxide emitted when the product 302 is manufactured and information on an amount of carbon dioxide emitted when the product 302 is transported by the transport vehicle 303. The company 201 (management device 200) acquires the information on each of the emission amounts of the product 302 from the company 301, a transport company that manages the transport vehicle 303, or the like.

Then, the management device 100 calculates an emission amount of carbon dioxide corresponding to one product 202 based on all the acquired information. Then, the management device 100 performs management by linking the calculated emission amount of carbon dioxide of one product 202 and the product 202 with each other. The emission amount of carbon dioxide of one product 202 may be calculated by the management device 200 (processor 210).

Management Method of Product

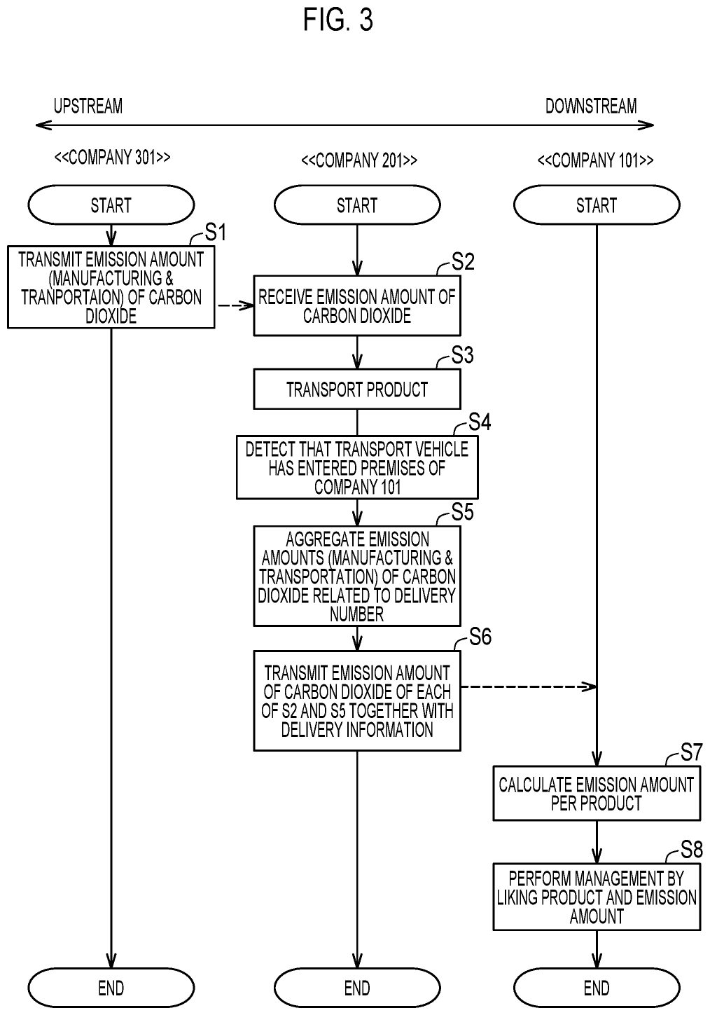

Next, a management method of the product 202 will be described with reference to the sequence diagram of FIG. 3. A management method of the emission amount of carbon dioxide of the product 202 will be described.

First, in step S1, the company 301 (management device 300) transmits, to the company 201, the information on the emission amount of carbon dioxide emitted by manufacturing the product 302 on a manufacturing line of the company 301. In addition, the company 301 (management device 300) transmits the information on the amount of carbon dioxide emitted from the transport vehicle 303 to the company 201 when the product 302 is transported by the transport vehicle 303. The company 301 (management device 300) may transmit, to the company 201, the total value of the amount of carbon dioxide emitted during manufacturing and the amount of carbon dioxide emitted during transportation. Alternatively, the amount of carbon dioxide emitted during transportation may be transmitted to the company 201 from the company that manages the transport vehicle 303.

In step S2, the company 201 (management device 200) receives the information on the emission amount of carbon dioxide transmitted in step S1. In a case where a company upstream of the company 301 is further provided, the company 201 (management device 200) may also receive information on an amount of carbon dioxide emitted by the upstream company and an amount of carbon dioxide emitted when a product is transported from the upstream company to the company 301.

In step S3, the company 201 transports the products 202 to the company 101 using the transport vehicle 402. The products 202 are transported by being packed in the packing box 204 (see FIG. 2). In the present embodiment, it is assumed that solely the packing box 204 is transported by the transport vehicle 402.

In step S4, the management device 200 (processor 210) of the company 201 detects that the transport vehicle 402 has entered the premises 101a of the company 101 based on the position information of the transport vehicle 402 acquired from the transport company 401. The transport company 401 acquires the position information of the transport vehicle 402 based on the signal from the GPS 402a mounted on the transport vehicle 402.

In step S5, the company 201 (management device 200) aggregates (calculates) the emission amounts of carbon dioxide of the products 202 of which delivery to the company 101 has been detected in step S4. Specifically, the management device 200 calculates the amount of carbon dioxide emitted by manufacturing the products 202 based on an electricity consumption amount of the manufacturing line of the products 202. In addition, the management device 200 also calculates the amount of carbon dioxide emitted by transporting the products 202 based on a fuel consumption amount of the transport vehicle 402 and a fuel emission coefficient. The company 201 acquires information on the fuel consumption amount of the transport vehicle 402, the fuel emission coefficient, and the like from the transport company 401. In addition, the calculation method for the emission amount of carbon dioxide is not limited to the example. The processing of step S5 may be performed before step S4.

In step S6, the company 201 (management device 200) transmits, to the management device 100 of the company 101, information on the amount of carbon dioxide emitted by each of the manufacturing and the transportation of the products 202 aggregated (calculated) in step S5. In addition, the management device 200 transmits, to the management device 100, the information on the amount of carbon dioxide emitted by each of the manufacturing and the transportation of the product 302 received in step S2. At this time, the emission amount of carbon dioxide to be transmitted may be appropriately calculated based on a ratio of the number of transported products 202 to the number of manufactured products 202, or the like.

Further, in step S6, the delivery information corresponding to the products 202 (packing box 204) is transmitted to the company 101 together with the information on the emission amount of carbon dioxide.

In step S7, the management device 100 calculates an emission amount of carbon dioxide per product 202. Specifically, the management device 100 calculates the emission amount of carbon dioxide per product 202 based on a ratio between the number of products 202 (302) manufactured by the company 201 (301) and the number of products 202 (302) transported by the transport vehicle 402 (303), or the like. The management device 100 may also take into account the number (quantity) of products 302 used to manufacture one product 202 to calculate the emission amount of carbon dioxide of one product 202.

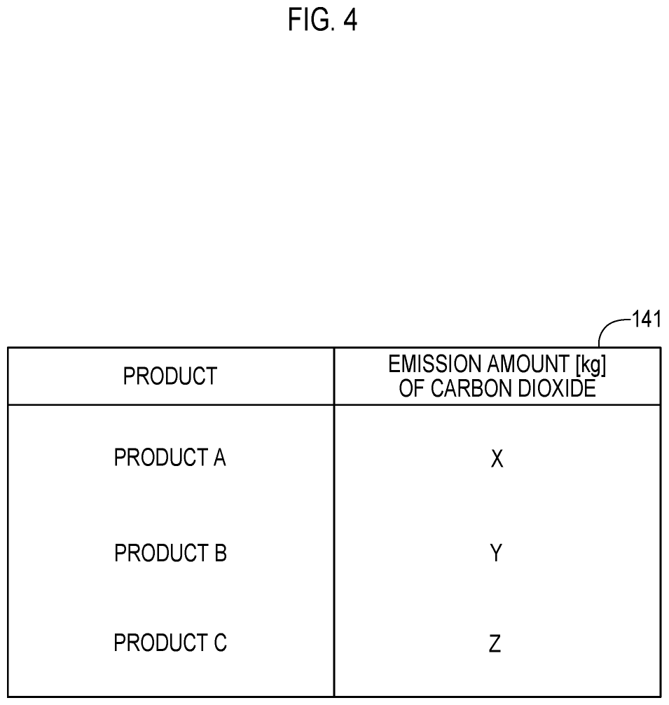

Then, in step S8, the management device 100 performs management by linking (associating) the emission amount of carbon dioxide per product 202 calculated in step S7 and the product 202 with each other. For example, the management device 100 may store a management table 141 (see FIG. 4) in which the product 202 and the emission amount of carbon dioxide are linked. FIG. 4 shows an example in which the emission amount of carbon dioxide is linked for each product (each of A, B, and C). In FIG. 4, products A to C are named to distinguish the products 202.

In addition, the company 101 (management device 100) links the emission amount of carbon dioxide to each of the delivered products (see FIG. 4), and manages the emission amount of carbon dioxide for each component. Then, the emission amount of carbon dioxide for each component used in the product 102 manufactured by the company 101 and the amount of carbon dioxide emitted in manufacturing the product 102 are added, thereby calculating an emission amount of carbon dioxide of the product 102.

As described above, in the present embodiment, in a case where the company 201 provided upstream detects that the transport vehicle 402 has entered the premises 101a of the company 101 provided downstream, the company 101 is notified of the information on the emission amount of carbon dioxide corresponding to the product 202 from the company 201. With this, the company 101 can automatically acquire the information on the emission amount of carbon dioxide when the transport vehicle 402 has entered the premises 101a of the company 101. As a result, there is no need to request the disclosure from the company 201. As a result, an increase in man-hours in the company 101 can be suppressed.

In the embodiment, an example has been described in which the emission amount of carbon dioxide per product and the product are linked with each other and managed, but the present disclosure is not limited thereto. For example, a plurality of delivered products and the total emission amount of carbon dioxide corresponding to the products may be linked with each other and managed. In this case, the emission amount of carbon dioxide may be managed in a unit of the packing box, or the emission amount of carbon dioxide may be managed in a unit of the transport vehicle.

In the embodiment, an example has been described in which the emission amount of carbon dioxide corresponding to the company 301 is transmitted to the company 101, but the present disclosure is not limited thereto. The emission amount of carbon dioxide corresponding to the company 301 need not be transmitted to the company 101.

In the embodiment, an example has been described in which the company 201 calculates the emission amount of carbon dioxide and transmits the information on the emission amount of carbon dioxide to the company 101, but the present disclosure is not limited thereto. For example, the company 101 (management device 100) may acquire, from the company 201, information on a power consumption amount of the manufacturing line of the company 201 and information on the fuel consumption amount of the transport vehicle 402 and the like, and calculate the emission amount of carbon dioxide by itself based on the acquired information.

In the embodiment, an example has been described in which the company 101 (management device 100) acquires, from the company 201, the information on the amount of carbon dioxide emitted in manufacturing and transporting the product 302, but the present disclosure is not limited thereto. The company 101 (management device 100) may acquire, from the company 301, the information on the amount of carbon dioxide emitted in manufacturing and transporting the product 302.

In a case where a plurality of types of products is transported at the same time, the amount of carbon dioxide emitted for transporting the products may be calculated based on a weight of the products. For example, an amount of carbon dioxide emitted for transporting one product may be calculated based on a ratio of a weight per product to the total weight of products loaded on the transport vehicle and the total amount of carbon dioxide emitted during transportation.

Further, a history of the emission amount of carbon dioxide corresponding to the product may be managed between a plurality of companies by blockchain.

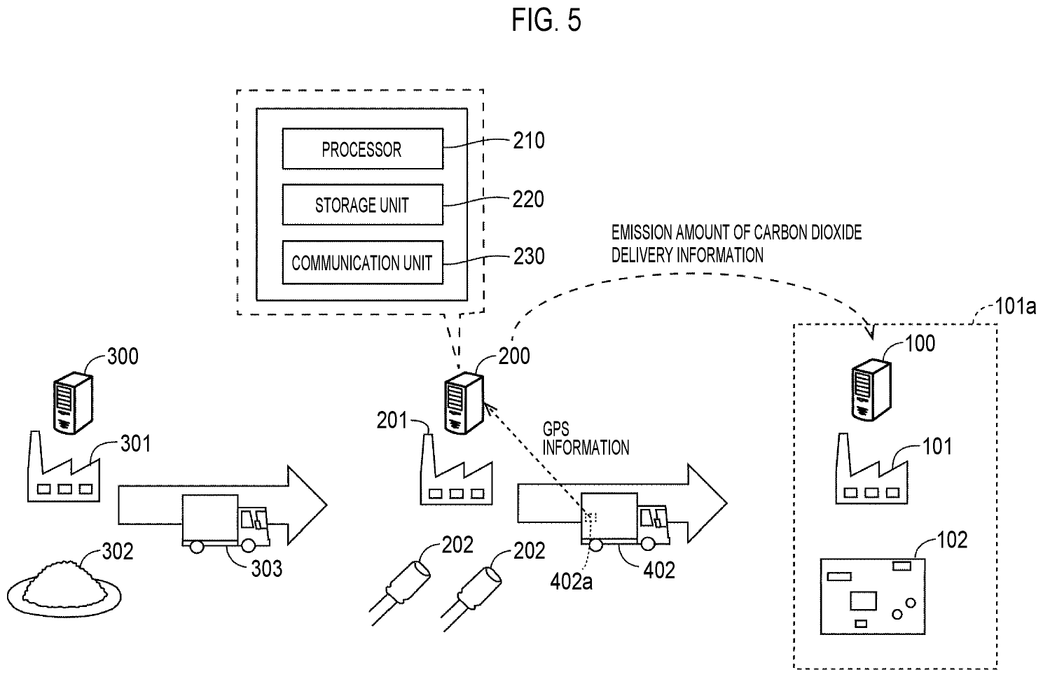

In the embodiment, an example has been described in which the company 201 (management device 200) acquires the position information of the transport vehicle 402 based on the notification from the transport company 401, but the present disclosure is not limited thereto. The company 201 (management device 200) may receive the signal of the GPS 402a of the transport vehicle 402 (see FIG. 5) and acquire the position information.

Further, in the embodiment, an example has been described in which the company 201 (management device 200) acquires the position information of the transport vehicle 402 based on the information of the GPS 402a, but the present disclosure is not limited thereto. The transport vehicle 402 need not be equipped with the GPS 402a. For example, the transport company 401 may grasp that the transport vehicle 402 has entered the premises 101a of the company 101 through communication with a driver of the transport vehicle 402 or the like. Alternatively, detection may be made that the transport vehicle 402 has entered the premises 101a of the company 101 based on the date and time when the transport vehicle 402 is scheduled to arrive at the company 101.

The embodiment disclosed this time should be considered illustrative and not restrictive in all respects. The scope of the present disclosure is indicated by the scope of claims rather than by the description of the above-described embodiment, and is intended to include all modifications within the scope and meaning equivalent to the scope of the claims.

What is claimed is:

1. A management device configured to manage a product to be delivered from a first company to a second company provided downstream of the first company, the management device being provided in the first company, the management device comprising:
a communication unit configured to acquire position information of a transport vehicle when the product is transported to the second company by the transport vehicle; and
a processor configured to perform control to notify the second company of information including an amount of carbon dioxide emitted by manufacturing the product, in a case where detection is made that the transport vehicle has entered premises of the second company based on the acquired position information.

2. The management device according to claim 1, wherein the communication unit is configured to acquire the position information based on global positioning system information of the transport vehicle.

3. The management device according to claim 1, wherein the processor is configured to perform control to notify the second company of the information including the amount of carbon dioxide together with delivery information including information regarding delivery of the product.

4. The management device according to claim 1, wherein:
a basic product constituting the product is supplied to the first company from a third company provided upstream of the first company; and
the processor is configured to perform control to notify the second company of information based on the amount of carbon dioxide emitted by manufacturing the product at the first company and an amount of carbon dioxide emitted by manufacturing the basic product at the third company.

5. A management method of managing a product to be delivered from a first company to a second company provided downstream of the first company, the management method comprising:
acquiring position information of a transport vehicle when the product is transported to the second company by the transport vehicle;
detecting that the transport vehicle has entered premises of the second company based on the acquired position information; and
notifying the second company of information including an amount of carbon dioxide emitted by manufacturing the product, in a case where detection is made that the transport vehicle has entered the premises of the second company.

6. A management system comprising:
a first management device provided in a first company; and
a second management device provided in a second company to which a product is delivered from the first company, the second company being provided downstream of the first company, wherein:
the first management device includes a communication unit configured to acquire position information of a transport vehicle when the product is transported to the second company by the transport vehicle, and a processor configured to perform control to notify the second company of information including an amount of carbon dioxide emitted by manufacturing the product, in a case where detection is made that the transport vehicle has entered premises of the second company based on the acquired position information; and
the second management device is configured to perform management by linking the product and the amount of carbon dioxide with each other based on the information including the amount of carbon dioxide provided through notification.
